(19) United States
(12) Patent Application Publication
(10) Pub. No.: US 2024/0411764 A1
(43) Pub. Date: Dec. 12, 2024

(54) RATE LIMITING FOR DATA QUERIES

(71) Applicant: Inigo Labs, Inc., Palo Alto, CA (US)

(72) Inventors: Eitan Joffe, Palo Alto, CA (US); Shachar Binyamin, Mountain View, CA (US)

(21) Appl. No.: 18/679,127

(22) Filed: May 30, 2024

Related U.S. Application Data
(60) Provisional application No. 63/471,457, filed on Jun. 6, 2023.

(51) Int. Cl. G06F 16/2455; G06F 21/62

(52) U.S. Cl. CPC G06F 16/24564; G06F 21/6227; G06F 21/6245

(57) ABSTRACT

The application relates to rate limiting for data queries. In one embodiment, a processing device receives, from a user device, a request comprising a query for data stored on a server. The request is associated with a user profile. The processing device identifies one or more parts of the query. Based on a set of rules associated with the user profile, the processing device identifies a subset of the one or more parts of the query that is accessible to the user profile. The processing device sends, to the server, a second query comprising the subset of the one or more parts of the query accessible to the user profile.

### RELATED APPLICATIONS

This application is related to and claims the benefit of U.S. Provisional Patent Application No. 63/471,457, filed Jun. 6, 2023, titled “Rate Limiting For Data Queries,” the entirety of which is incorporated herein by reference.

### TECHNICAL FIELD

This disclosure relates to the field of rate limiting for data queries, and more particularly, to rate limiting for GraphQL®.

### BACKGROUND

Rate limiting can be used to control the rate of network traffic. Rate limiting algorithms place limits on the rate of requests sent or received by a network interface controller, to prevent the frequency of requests from exceeding a set limit. An example of rate limiting is a limit on the number of application programming interface (API) calls an application or service can make, within a particular time window, by a particular user. Rate limiting can protect resources from being overused.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 is a block diagram illustrating an example network architecture operating in accordance with embodiments of the present disclosure.

FIG. 2 is a block diagram illustrating an example computer system, in accordance with embodiments of the present disclosure.

FIG. 3 is a block diagram illustrating a request processing system, in accordance with embodiments of the present disclosure.

FIG. 4 is a flow diagram illustrating a method for inbound rate limiting, in accordance with embodiments of the present disclosure.

FIG. 5 is a flow diagram illustrating a method for outbound rate limiting, in accordance with embodiments of the present disclosure.

FIG. 6 is a block diagram of an example computing device in which embodiments of the present disclosure may operate.

### DETAILED DESCRIPTION

Embodiments are described with regards to rate limiting for data queries. Some embodiments, in particular, are directed to rate limiting for GraphQL and/or other query languages that permit complex queries that can return large quantities of data responsive to a single query. Rate limiting is used to control the rate of requests sent or received via a network. Rate limiting can control the amount of resources used by various services and/or applications in a network environment. Resources can include, for example, memory and CPU usage, and/or time spent fulfilling requests. Conventional rate limiting for data queries can limit the number of queries sent to a particular endpoint (e.g., a particular application programming interface (API), or particular uniform resource locators (URLs)). For instance, data can be queried from various URLs of a server, and the entire data payload for each queried URL can be returned. Conventional rate limiting places limits on the number of requests sent to each endpoint (i.e., URL) within a particular time window or over a particular time period (e.g., per day, per hour, per minute). Each endpoint can return a fixed data structure. For example, a user can use a first endpoint (e.g., API or URL) to fetch user data (e.g., user ID, username), a second endpoint to fetch a list of followers for a user, and a third endpoint to fetch articles shared by a user. The user would send three queries to three endpoints in order to fetch the desired information. Conventional rate limiting places a limit on the number of queries sent to each endpoint, to protect against excessive use of resources to maintain the availability of the endpoint.

However, conventional rate limiting on a single entry point that can access the entire database (e.g., using GraphQL) may not provide the desired level of protection. GraphQL is a data query and manipulation language for application programming interfaces (APIs). GraphQL provides a complete description of the data accessible by an API. A backend developer can develop a schema for data, which enables front-end users of the API to explore and request specific data. Rather than providing multiple URLs, a GraphQL API provides a single endpoint through which data can be queried. A user can query the API using a syntax that can work with any programming language. Thus, to expand on the example provided above, a single query to the API using GraphQL can fetch user data (e.g., user ID, username), a list of followers for a user, and articles shared by a user. The response can become very large, very quickly. Thus, applying a rate limit based on the endpoint may not provide a sufficient level of security against resource overuse when applied to a query language such as GraphQL. For example, a first query sent to a GraphQL API endpoint can return just a few data objects, while a second query sent to the same GraphQL API endpoint can return thousands (or millions) of data objects. Accordingly, applying rate limits based on the GraphQL API endpoint can be ineffectual.

Aspects of the present disclosure address the above-noted and other deficiencies by implementing rate limiting based on the content of the query by contextualizing the request. As described in embodiments of the present disclosure, rate limiting can include inbound rate limiting and outbound rate limiting. Inbound rate limiting can place rate limits on a query based on the content of the query prior to fulfilling the query, whereas outbound rate limiting can analyze the response and update the rate limits based on a result of such analysis (i.e., the rate limits that are imposed during inbound rate limiting for the next incoming query).

In some embodiments, rate limiting can be implemented on a server device associated with a client. Each client can establish a set of rules for implementing rate limiting on requests received from user devices. The rules can set rate limits at a variety of granularities associated with a request. A rule can be based on the type of data requested. A rule (or a set of rules) can be specific for each user profile of the requestor, and/or for groups of user profiles (e.g., associated with a role of the user). Multiple rules can be applied to one query. A configuration component can configure rate limit rules according to a client's input. The configured rate limit rules can be implemented by the client (e.g., on a client's server device) during an inbound rate limiting phase, to impose rate limits on incoming data requests received from user devices associated with the server device. The configuration component can update or reconfigure the rate limit rules for a client based on output received from the server device. For example, the server device can send output to the configuration component during the outbound rate limiting phase. The configuration component can then send the updated rate limit rules to the client's server device for further rate limiting.

The server device can implement a rate limiting component using the rate limit rules received from the configuration component. The inbound rate limiting phase of the rate limiting component can include parsing a query received in a request from a user device connected to the server device. The rate limiting component can parse the request to identify parts of the query. The rate limiting component can identify the rate limit rules applicable to the request (e.g., based on the user profile or user ID), and can map the identified parts to the rules associated with the request. The rate limiting component can then identify the parts of the query that are accessible to the user device, and process the accessible parts of the query while blocking the inaccessible parts of the query.

A query (or a part of a query) is accessible to the user device if it satisfies the rules applicable to the request, and/or if the user has sufficient rate limit credits available at the time the query is received. The rules can place limits at a variety of granularities associated with the request, such as the type of data requested, the number of objects requested, the expected time or resources that will be consumed to generate a response, the expected number of fields to be included in the response, the role of the requestor, and/or the time frame in which the request was received. In some embodiments, the rate limiting component can assign a numerical value to the parts of the query and/or the query as a whole, and can compare the numerical values to a requestor's rate limit credits to determine whether the requestor has sufficient credits available. Rate limit credit levels can help ensure that a requestor is not abusing or over-using the client server. The rate limit credits can represent how many resources the requestor is allowed to consume, and/or how many requests the requestor is allowed to make within a certain time frame, for example.

The rate limiting component can determine that the query as a whole is accessible to the requestor and can enable the query to be processed by the server device. In some implementations, the rate limiting component can determine that a part (or parts) of the query are inaccessible to the requestor, based on the rules and/or the requestor's available rate limit credits. The rate limiting component can enable the parts of that query that are accessible to the user to be processed by the client server, while blocking the parts of the query that are inaccessible to the user to be processed by the client server. The rate limiting component can store information describing the inaccessible part(s) of the query, such as a reason why each corresponding part is inaccessible. In some embodiments, the rate limiting component can then generate a second query that includes the part(s) that are accessible to the requestor. The client server can then process, and generate a response to, the query that the rate limiting component has deemed accessible to the requestor.

Once a response is generated, the outbound rate limiting component can analyze the response, send a response to the user device, and can update the rate limits imposed during the inbound rate limiting. In some embodiments, prior to sending the response to the user device, the outbound rate limiting component can remove personal identifying information from the generated response and/or can remove data included the generated response that is not intended for the requestor (e.g., debug information). In some embodiments, the outbound rate limiting component can append, to the response, data regarding the part(s) of the query that the inbound rate limiting component determined were inaccessible to the requestor. For example, prior to sending the response to the user device, the outbound rate limiting component can identify which part(s) of the query were inaccessible to the requestor based on the rate limit rules and/or based the requestor's rate limit credits, and can append data identifying the inaccessible part(s). Additionally or alternatively, the outbound rate limiting component can append, to the response, data indicating the reason(s) why the inaccessible part(s) were determined to be inaccessible.

In some embodiments, the outbound rate limiting component can determine the size of the returned data in the response. The outbound rate limiting component can analyze the response to determine the amount of data returned, the amount of each data type returned, and/or the number of fields returned. The outbound rate limiting component can also identify the amount of resources consumed to generate the response, and/or the amount of time it took to generate the response. Such metrics can represent the load that fulfilling the query imposed on the system. In some embodiments, the outbound rate limiting component can further limit the request, for example, if the response consumed an amount of resources that exceeds a defined threshold, or the amount of time to generate the response exceeds a threshold time period.

The outbound rate limiting component can assign a score to the generated response. The score can be based on the amount of data returned, the type of data returned, the resources consumed in generating the response, and/or on other granularities associated with the rate limit rules for the requestor. In some embodiments, the score can be an aggregate score of a number of sub-scores. The outbound rate limiting component can update the rate limit credits available to the requestor by a factor that corresponds to the score of the generated response. In some embodiments, the factor can be the score of the generated response. In some embodiments, the factor can be a weighted value of the score of the generated response. For example, the outbound rate limiting component can place a higher weight on the score of responses that are generated in a high-volume time period for the server device. In some embodiments, the outbound rate limiting component can apply each sub-score to different rate limit credit categories (e.g., for each type of data, for each field).

In some embodiments, the outbound rate limiting component can update the rate limit credits available to the requestor by subtracting the score of the generated response (or a factor corresponding to the score) from the requestor's available rate limit credits. Then, future requests received from a user device associated with the requestor will be compared against the updated available rate limit credits. Note that a requestor's available rate limit credits can be based on a time window, and thus can reset to their initial values once the time window has elapsed. That is, rate limit credits can control the amount of requests (and/or types of requests) sent and/or received from a particular requestor within a certain time window. Once the time window has elapsed, the rate limit credits can be reset (e.g., restored to their starting values). In some embodiments, a requestor's rate limit credits can be reset to their initial value(s) if a request has not been received from the requestor for a certain period of time.

Advantages of the present disclosure include, but are not limited to, improved security and protection for servers using APIs for query languages such as GraphQL APIs. Aspects of the present disclosure protect such APIs (e.g., GraphQL APIs) by implementing rate limiting based on the content of the query, rather than based on the number of requests sent to the API. Furthermore, by providing the rate limiting component to be implemented by the client's server device, aspects of the present disclosure provide for low latency and high throughput of requests fulfilled by the client's server device. The communication between the client's server device and the rate limit configuration component operated in the cloud enables the rate limiting described herein to continuously monitor the data returned from the server. Based on this monitoring, the rate limiting described herein can update the rate limit configurations dynamically, based on real traffic processed by the server device. The rate limiting described herein protects the client's server devices, accessible via a single endpoint, from attacks (such as request bursts, resource starvation, resource overuse, etc.) by contextualizing the request and applying rate limit rules to the content of the query.

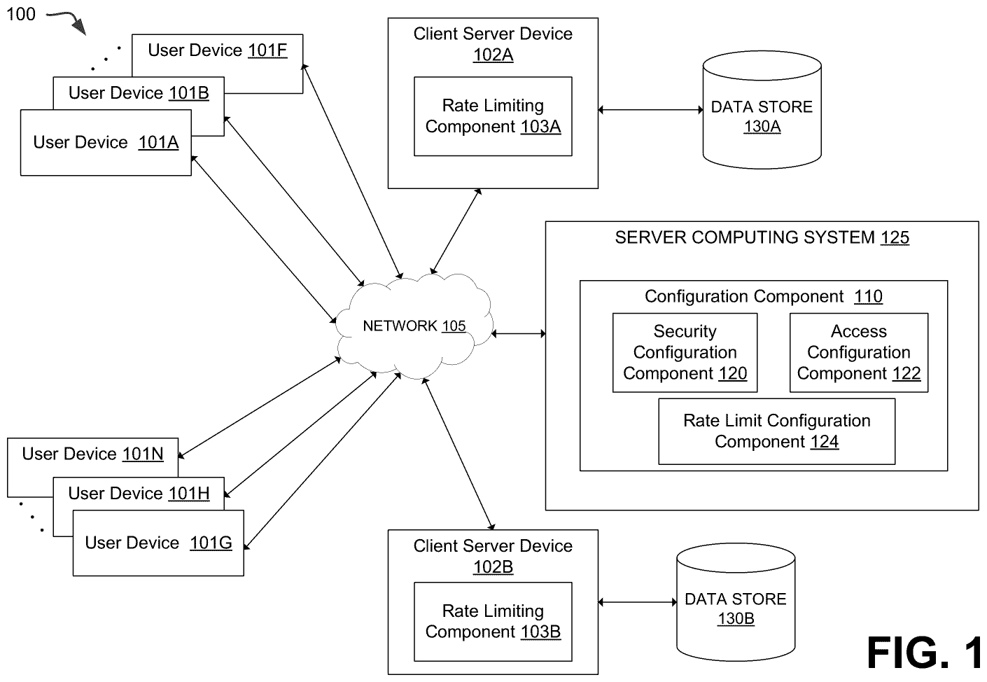

FIG. 1 is a block diagram illustrating an example network architecture 100, in accordance with embodiments of the present disclosure. The network architecture 100 includes one or more user devices 101A-N connected to one or more client server devices 102A-B and/or to one or more server computing systems 125 via a network 105. In some embodiments, user devices 101A-F can connect to client server device 102A, and user devices 101G-N can connect to client server device 102B. In some embodiments, the user devices 101A-N can be connected to client server devices 102A,B directly, and/or via networks different from network 105. Examples of user devices 101A-N can include computing devices (e.g., desktop computers, laptop computers), and/or mobile devices (e.g., mobile phones, tablets), or other computing devices. In some embodiments, server computing system 125 and/or client server devices 102A-B can operate in a cloud environment.

In embodiments, network 105 can include a wide area network (WAN), which can be a private WAN (e.g., an intranet) or a public WAN such as the Internet, or may include a combination of a private and public network. In some embodiments, network 105 can include a local area network (LAN), which can include a router, switch, bridge, or other network device (not shown) that enables communication between multiple devices connected to the LAN. The network device can provide wired connections to the LAN using, for example, Ethernet ports, universal serial bus (USB) ports and/or Firewire® ports. The network device may additionally provide wireless connections to the LAN using, for example, a Wi-Fi transceiver.

Client server devices 102A-B can be connected to a server computing system 125 via network 105. In some embodiments, client server devices 102A-B can be connected to server computing system 125 via a network other than network 105, and/or can be connected directly to configuration component 110. Client server devices 102A-B can also include, or be connected to, a data store 130A-B. Data store 130A,B can each store data associated with the corresponding client server device 102A,B. User devices 101A-N can send queries to client server devices 102A,B to request access to data stored in data stores 130A,B.

Client server devices 102A-B, and/or server computing system 125, can each include a physical machine and/or a virtual machine hosted by a physical machine. The physical machine can be a rackmount server, a desktop computer, or other computing device. In one embodiment, the client server devices 102A-B and/or server computing system 125 can include a virtual machine managed and provided by a cloud provider system. Each virtual machine offered by a cloud service provider may be hosted on a physical machine configured as part of a cloud. Such physical machines are often located in a data center. The cloud provider system and cloud may be provided as an infrastructure as a service (IaaS) layer. The client server devices 102A-B can host a rate limiting component 103A-B. The server computing system 125 can host a configuration component 110.

Configuration component 110 can include a security configuration component 120, an access configuration component 122, and/or a rate limit configuration component 124. Configuration component 110 can configure security, access, and/or rate limit rules. Configuration component 110 can configure the rules based on input received from a client (e.g., from client server device 102A,B), and/or based on metrics associated with processing requests by a client (e.g., client server device 102A,B). The metrics can include, for example, the time and/or resources consumed while processing requests to generate responses. The rate limit rules can limit the number of and/or frequency of queries sent from a user device 101A-N based on the content of the request. The access rules can place limits on how certain data fields can be accessed, and/or which roles have access to certain data fields in data stores 130A,B. The security rules can implement certain security features to protect data stored on data stores 130A,B, and/or to protect client server devices 102A,B from over-use or abuse by a client device 101A-N. The configuration component 110 can send the configured rules to the client server device 102A,B.

The rate limit configuration component 124 can configure rate limit rules for each client server device 102A,B. The rate limit rules can be based on input from the client server device 102A,B, and/or based on historical analysis of queries processed by client server device 102A,B. The input from the client server device 102A,B can include rules for different profiles of users. The rate limit rules can also apply rate limits based on the types of data requested. For example, a rule can limit users associated with profile A to X number of requests for a specific data type, and a second rule can limit users associated with profile B to Y number of requests for the specific data type. The rules can vary per time window. Thus, a first rule can limit profile A to X number of requests for a specific data type per minute, and a second rule can limit profile A to Z number of requests for the specific data type per hour. Rules can have additional levels of granularity, for example, based on the number of fields requested, based on the path of the data requested, and/or based on other parts of the query. A path (or data path) refers to the path that is followed to access a specific data object from a server. A data path is the sequence of fields and relationships that are traversed to reach a particular data point. A data path can represent the relationship between objects.

In some embodiments, the rate limit configuration component 124 can configure the rules based on historical analysis of queries by the client server device 102A,B. That is, configuration component 110 can receive and/or store analysis information received from client server device 102A,B. The analysis information can include the amount of resources used to generate a response to a particular query, the amount of time it took to generate the response, and/or other metrics associated with fulfilling requests by client server device 102A,B. The analysis information can also include the amount of data returned for each part of the query. The rate limit configuration component 124 can assign a numerical value to data types, paths, fields, queries, and/or parts of queries based on the analysis information. The numerical value can represent a cost associated with the corresponding query, or the corresponding part of the query. In some embodiments, the numerical value can represent an average cost, calculated over a specified period of time. For example, the numerical value can represent the average cost of returning a response for a particular data field over the past 30 days. The cost can be the amount of time it took to return the response, the amount of resources consumed in generating the response, the amount of data returned in the response, and/or a combination of these values (the combination can be a weighted combination in which one value is given more weight than the other(s)). The computed numerical value can be assigned to each rule. The rate limiting configuration component 124 can send the generated rules to each corresponding client server device 102A,B.

Rate limiting component 103A,B can apply the rate limit rules received from configuration component 110. Rate limiting component 103A,B can impose inbound rate limits on a request received from a user device 101A-N. Imposing inbound rate limits can include parsing the request into a format that can be mapped to the rules received from configuration component 110. Rate limit component 103A,B can maintain rate limit credits for each user device 101A-N. Once the request is mapped to the rules, rate limiting component 103A,B can identify the parts of the request that satisfy the rules (i.e., a profile associated with the user device 101A-N that sent the request has sufficient rate limit credits), and can generate a query that includes that parts of the request that satisfy the rules. The generated query can then be fulfilled, e.g., by accessing the queried data from data store 130A,B. Rate limiting component 103A,B can then apply an outbound rate limit on the response that includes the queried data.

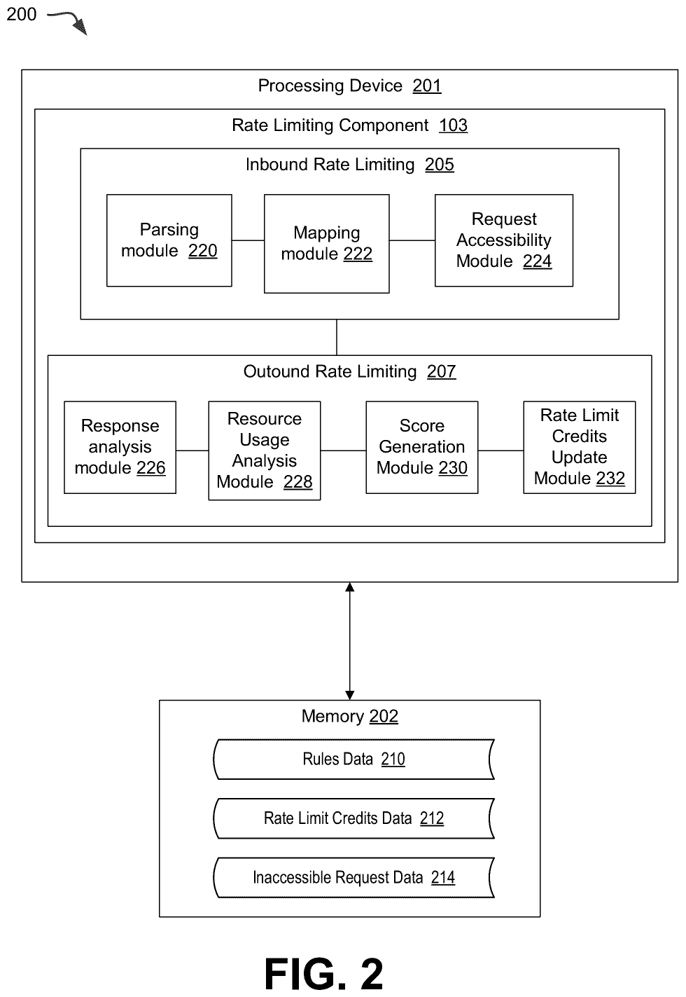

Outbound rate limiting can include analyzing the response to identify the amount of data included in the response, which can include an amount of each type of data in the response. Outbound rate limiting can identify the amount of resources used to fulfill the request (e.g., CPU cycles, memory usage), the amount of time it took to fulfill the request, and/or other metrics that quantify the load imposed on the system to fulfill the request. Based on the amount of resources used and/or on the amount of data returned in the response, the rate limiting component 103A,B can compute a score for the response. The score can be a single score, and/or can include multiple sub-scores for various levels of granularity. The rate limiting component 103A,B can then update the rate limit credits for the specific requestor by a factor associated with the computed score. The rate limiting component 103A,B can also send the identified metrics and/or the score to configuration component 110, which can then reconfigure the rate limit rules for the corresponding client server device 102A,B. Rate limiting component 103A,B is further described with respect to FIG. 2.

FIG. 2 depicts a block diagram illustrating a computer system 200, operating in accordance with one or more aspects of the present disclosure. Computer system 200 may be the same as or similar to server device 102A,B of FIG. 1. Computer system 200 can include a rate limiting component 103, and a memory 202 that can store rules data 210, rate limit credits data 212, and/or inaccessible request data 214. The rules can be associated with a specific user, a profile (which can be associated with a user role), an IP address, a user device, or any other level of granularity. The rate limit credits 212 can keep track of an amount of available credits for each requestor for each level of granularity and/or for each rule in rules data 210.

As an illustrative example, the rules data 210 can be a data structure (e.g., a list or a table) of rules for various levels of granularity of data queries. Levels of granularity can correspond to different parts of the query. For example, each level of granularity can correspond to a certain type of data stored, and thus rules data 210 can include a rule for each type of data stored. The rules data 210 can include a numerical value for each level of granularity, which can illustrate the amount of resources expected to be consumed to process a query at that level of granularity. Additionally or alternatively, the levels of granularity can correspond to the requestor. For example, rules in rules data 210 can be defined for each user, for each IP address, for each role, and/or for each user profile associated with the user device from which the request is received (e.g., user device 101A-N). Rate limit credits data 212 can be a data structure (e.g., a table) that stores the amount of available credits for each user (e.g., each requestor). Rate limit credits data 212 can store an amount of available credits corresponding to a rule in rules data 210. For example, for each rule in rules data 210, rate limit credits data 212 can store an amount of available credits for a particular user (e.g., associated with user device 101A-N).

The rate limiting component 103 can perform the same functions as rate limiting component 103A-B, as illustrated in FIG. 1. The rate limiting component 103 can include an inbound rate limiting component 205 and an outbound rate limiting component 207. The inbound rate limiting component 205 can include a parsing module 220, a mapping module 222, and/or a request accessibility module 224. The outbound rate limiting component 207 can include a response analysis module 226, a resource usage analysis module 228, a score generation module 230, and/or a rate limit credits update module 232. In embodiments, each of the modules may be or include logic configured to perform a particular action or set of actions. In embodiments, one or more of the modules may be combined into a single module. In embodiments, the functions of one or more modules may be divided into sub-modules.

In embodiments, the parsing module 220 can enable a processor to parse a query received in a request for data from a user device (e.g., user device 101A-N of FIG. 1). The parsing module 220 can access the query in the request and identify parts of the query. The parts of the query identified by the parsing module 220 can include different types of data requested in the query, different fields requested in the query, the number of each type of data and/or field requested in the query, and/or a path of the data requested in the query. In some embodiments, the parsing module 220 can parse the query into an abstract syntax tree. Each node in the tree can represent a different type of data, and each node in the tree can have a rule associated with it in rules data 210. That is, the parts of the query can correspond to rules in rules data 210.

In embodiments, the mapping module 222 can enable a processor to map the parsed request to rules stored in rules data 201. The mapping module 222 can identify the rule in rules data 210 for each part of the query identified by parsing module 220. For each rule in rules data 201 that corresponds to a part identified by the parsing module 220, the mapping module 222 can assign an object (e.g., a numerical object) to the corresponding part. The object can be based on the numerical value associated with the corresponding rule in embodiments. In embodiments, the mapping module 222 can compute an overall object for the request as a whole, which can be a combination of the objects (e.g., numerical objects) corresponding to each part of the query (e.g., a combination of numerical objects based on the numerical value associated with the rule corresponding to the part of the query). The combination can be a weighted combination, in which some parts carry more weight than other parts of the query.

In embodiments, the request accessibility module 224 can enable a processor to determine whether the requestor has sufficient rate limit credits for the requestor to satisfy the query. The rate limit credits for the requestor can be stored in rate limit credits data 212. The rate limit credits data 212 can store the amount of credits that a user has left. In embodiments, the amount of credits can be applied over a threshold period of time. That is, the amount of rate limit credits can be restored to an initial value at the expiration of a threshold period of time (e.g., every hour), and/or the amount of rate limit credits can be restored to an initial value if a request has not been received from the corresponding requestor for a certain amount of time.

To determine whether a requestor has sufficient rate limit credits to satisfy the request, the request accessibility module 224 can compare the object determined by mapping module 222 to the requestor's rate limit credits stored in rate limit credits 212. For example, if the object for the request, determined by mapping module 222, exceeds the requestor's available rate limit credits, the request accessibility module 224 can determine that the requestor does not have sufficient credits available. Thus, the request accessibility module 224 can block the request from being processed (e.g., by client server device 102A,B).

In some embodiments, rate limit credits 212 can be broken up into multiple buckets, or categories. The buckets can correspond to the different levels of granularity in the request, for example. The request accessibility module 224 can compare the requestor's available rate limit credits in each bucket to the object corresponding to each part of the request, as identified by mapping module 222. The request accessibility module 224 can block the parts of the request for which the requestor does not have sufficient corresponding available rate limit credits, while permitting other parts of the request for which the requestor does have sufficient rate limit credits available. The request accessibility module 224 can store information describing the part(s) of the query that are inaccessible to the requestor (which can be the entire query) in inaccessible request data 214. The information describing the inaccessible part(s) of the query can include information describing which rule has blocked the part of the request.

In some embodiments, the inbound rate limiting component 205 can generate a second query that includes the part(s) of the query that are accessible to the requestor. In some embodiments, the second query can be the same as the first query (e.g., if the entire query in the received request satisfies the rules). The inbound rate limiting component 205 can send the second query to a query processing component (not illustrated), which can query the corresponding data store 130A,B and generate a response to the query. In some embodiments, if the entire query is determined to be inaccessible to the requestor by request accessibility module 224, the inbound rate limiting component 205 can block the query from being processed.

Outbound rate limiting component 207 can enable a processor to receive and process a response to the query. Response analysis module 226 can enable a processor to identify the parts of the response, including, for example, how many different types of objects are returned, how many different fields are returned, a count of each field and/or of each object returned, and/or a size of the response. Resource usage analysis module 228 can enable a processor to identify the resources consumed to generate the response, and/or the amount of time it took to generate the response.

Score generation module 230 can enable a processor to generate a rate score for the response based on the resource usage from resource usage analysis module 228 and/or the response analysis from response analysis module 226. That is, the score generation module 230 can generate a rate score that represents the amount of resources consumed to generate the response, the amount of time spent on processing the request, and/or the size and content of the response. The score can be an aggregate score of multiple sub-scores. Each sub-score can correspond to a different rule, and/or to a different level of granularity included the response.

Rate limit credits update module 232 can enable a processor to identify a profile associated with the requestor, and to update the rate limit credits data 212 for the identified profile by a factor corresponding to the rate score generated by score generation module 230. In some embodiments, the factor can be the score of the generated response. In some embodiments, the factor can be a weighted value of the score of the generated response. For example, the outbound rate limiting component can place a higher weight on the score for responses that are generated a high-volume time period for the server device. In some embodiments, the outbound rate limiting component can apply each sub-score to different rate limit credit categories (e.g., for each type of data, for each field).

In some embodiments, the response analysis module 226 and/or the resource usage analysis module 228 can send the analysis information to configuration component 110 of FIG. 1. Configuration component 110 of FIG. 1 can then use the received analysis information to update (or reconfigure) the rules data 210 used by rate limiting component 103.

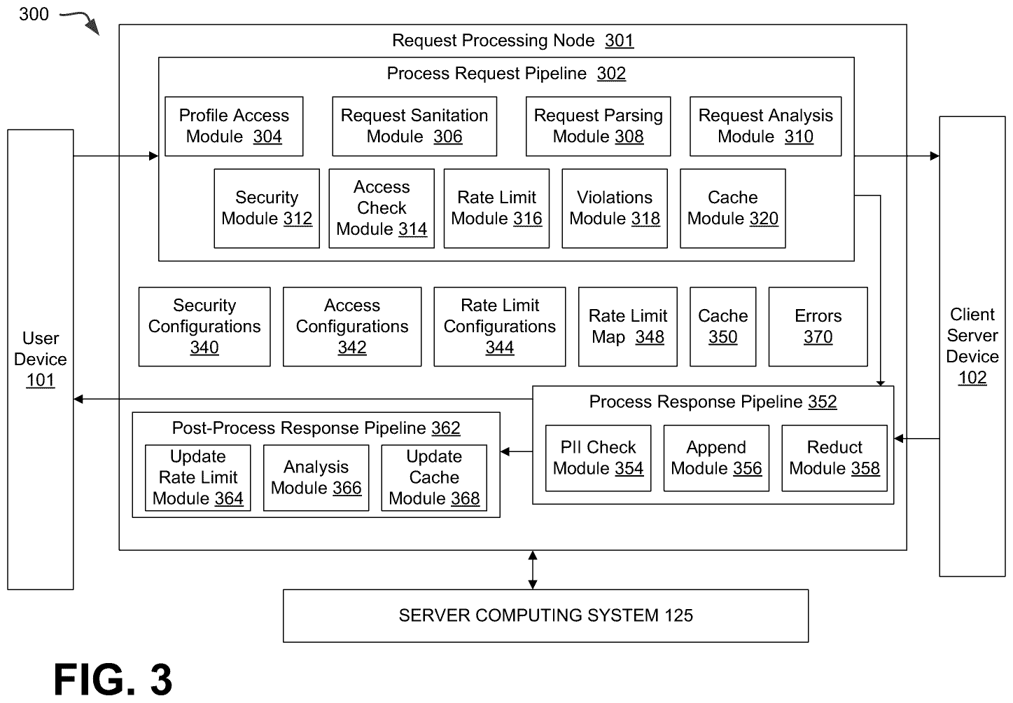

FIG. 3 is a block diagram illustrating a request processing system 300, in accordance with embodiments of the present disclosure. The request processing system 300 can include a request processing node 301 coupled to a user device 101, a client server device 102, and a server computing system 125 (e.g., via a network). In some embodiments, request processing node 301 can be a part of the client server device 102.

The request processing node 301 can operate as a gateway (e.g., a hosted or an on-premises gateway), a middleware, or a sidecar for server devices 102A-B. The request processing node 301 can be connected to a user device 101, to a server computing system 125, and to a client server device 102, e.g., via one or more networks (not illustrated). In some embodiments, the request processing node 301 can be part of the client server device 102. In other embodiments, the request processing node 301 can be part of a network interface card (NIC). The request processing node 301 can include a process request pipeline 302, a process response pipeline 352, and post-process response pipeline 362. The request processing node 301 can also include security configurations 340, access configuration 342, rate limit configurations 344, rate limit map 348, and a cache 350.

Security configurations 340 can store security rules received from server computing system 125, and used by security module 312. Access configurations can store access rules received from server computing system 125 (i.e., configuration component 110), and used by access check module 314. Rate limit configurations 344 can store rate limit rules received from server computing system 125 (i.e., configuration component 110), and used by rate limit module 316. Rate limit map 348 can store the available rate limit credits for each requestor. In some embodiments, rate limit map 348 can store an available rate limit corresponding to each rule in rate limit configurations 344. That is, rate limit map 348 can store the available rate limits for a requestor for each level of granularity that has a corresponding rule in rate limit configurations 344. Rate limit maps 348 can also store an overall available rate limit for each requestor. Cache 350 can store a cache of recent queries performed on client server device 102. Errors 370 can store information associated with the outcomes of the operations performed at modules 304-320 (i.e., performed during outbound rate limiting).

The request processing node 301 can receive a request from user device 101. The request can include a query for multiple types of data sent to a single endpoint (e.g., a single API or URL). The request processing node 301 can process the request via process request pipeline 302. In some embodiments, process request pipeline 302 can perform at least some of the same functions as inbound rate limiting component 205 of FIG. 2.

Process request pipeline 302 can include a profile access module 304, a request sanitation module 306, a request parsing module 308, a request analysis module 310, a security module 312, an access check module 314, a rate limit module 316, a violations module 218, and/or a cache module 320.

Profile access module 304 can identify a user profile associated with the user device 101 from which the request was received. The user can also be referred to as the requestor herein. In some embodiments, the request can include a user ID identifying the user profile. In some embodiments, the user profile can be identified based on the user device 101 from which the request was received. The identified user profile can specify, for example, a role (or set of roles) assigned to the user. The profile access module 304 can identify the role(s) that match the received request. In some embodiments, the profile access module 304 can identify the IP address of the user device 101 from which the request was received, and can identify the user profile using the IP address.

Request sanitation module 306 can sanitize the received request by removing any identified private or sensitive data in the request, such as passwords, social security numbers, credit card information, email addresses, addresses, etc.

Request parsing module 308 can parse the received request. Request parsing module 308 can identify the query string included in the request and can parse it into objects that are related to each other, in a format that can be processed. For example, request parsing module 308 can parse the query into an abstract syntax tree. Request parsing module 308 can identify different parts of the query. A part of the query can be the objects being requested, the types of data being requested, the path of the data being requested, the fields being requested, etc.

Request analysis module 310 can analyze the parsed query to determine an object (e.g., a numerical object) for the query. The object can represent an estimated score for fulfilling the request in embodiments. In some embodiments, the estimated score can be based on the different parts of the query. For example, the estimated score can be based on the number of branches in a path of the syntax tree, the number of objects being requested, the number of each type of data being requested, the number of each field being requested, etc. The estimated score can include one overall number, and/or can include multiple sub-scores for different parts of the query.

Security module 312 can provide safeguards to the server device 102 by limiting queries based on the depth of the query. Security module 312 can access security configurations 340. In some embodiments, security configurations 340 can be established via the security configuration component 120 of FIG. 1. Security configurations 340 can include limitations that provide additional security for client server device 102. In some embodiments, security module 312 can prevent a query from progressing to the server device 102 based on the shape or style of the query. For example, security module 312 can limit queries to paths of four-fields deep. The security policies can be received from a client and configured in security configuration component 120 of FIG. 1. Security module 312 can identify a part (or parts) of the query that do not satisfy the security configurations 340, and can block the identified part(s) from reaching the client server device 102 by removing the part(s) from the query. Security module 312 can store information related to the identified part(s) in errors 370.

Access check module 314 can apply rules on particular fields in the database based on access configurations 342. Access configurations 342 can include rules that limit access to certain parts of a query (e.g., certain fields, or certain data types) based on the requestor's profile. As an illustrative example, certain fields can be restricted to requestors that have an administrator role. The access check module 314 can remove parts of the query for which the requestor does not have access. The access check module 314 can add information about the removed parts to errors 370.

Rate limiting module 316 can identify the rate limit configurations 344 that are associated with the parts of the query identified by request parsing module 308. The rate limit configurations 344 can include one or more rules for each part of the query. The rate limit configurations 344 can specify the amount of credits needed to satisfy each part of the query. Rate limiting module 316 can use the rate limit map 348 to determine whether the requestor has sufficient credits to fulfill each part of the query. If not, the rate limiting module 316 can block the query from progressing. In some embodiments, rate limiting module 316 can block the parts of the query for which the requestor does not have sufficient credits to fulfill, while permitting other parts of the query for which the requestor does have sufficient credits to fulfill. That is, if the requestor has sufficient credits to fulfill half of the query, the rate limiting module 316 can remove half of the query and store associated information in errors 370.

Violations module 318 can determine whether the request is attempting to inject information into variable fields in the data store (e.g., data store 130A,B). Violations module 318 can block such inject-style attacks. Cache module 320 can determine whether the requested data is stored in cache 350. If so, cache module 320 can retrieve the cached data from cache 350, and return the cached data to the user device 101. Cache module 320 can help reduce the load on client server device 102 by not performing the same query multiple times.

Once the response passes through the process request pipeline 302, a query is sent to client server device 102. The query sent to client server device 102 may not be the same as the query in the request received from user device 101. That is, modifications may be made the query based on the outcomes of modules 304-320. In some embodiments, a second query is generated based on the outcomes of module 304-320.

In some embodiments, if the request fails at least one of the modules 304-320 in the process request pipeline 302, the request may not be sent to client server device 102. In such instances, the request processing node 301 can send a notification to user device 101. The notification can include an error message, which can identify at which step(s) the request failed. In some embodiments, the error message can be a generic error message that does not provide additional information about at which step(s) the request failed. In some embodiments, even though a query was not sent to data store 130, the request can pass through the processing response pipeline 352 and/or the post-process response pipeline 362.

Client server device 102 can process the received query (e.g., the second query) and return a response, e.g., in the form of a JSON file. Request processing node 301 can receive a response to the query from client server device 102. The request processing node 301 can process the response via process response pipeline 352 and/or post-processing response pipeline 362. In some embodiments, process response pipeline 352 and/or post-processing response pipeline 362 can perform at least some of the same functions as outbound rate limiting component 207 of FIG. 2.

The process response pipeline 352 can include a personally identifying information (PII) check module 354, an append module 256, and/or a reduct module 258. The PII check module 354 can identify personally identifying information in the response received from client server device 102, and can remove the identified personally identifying information. Examples of personally identifying information can include social security numbers, credit card numbers, driver's license numbers, taxpayer identification numbers, etc. In some embodiments, the client can identify which types of personally identifying information is to be removed from the response.

The append module 356 can append errors (e.g., stored in errors 370) that resulted from the operations performed at modules 304-320. That is, if the query was modified based on one of the modules 304-320, information regarding the modification is appended to the response. For example, if the security module 312 determined that one part of the query exceeded the security configurations 340 and blocked that part of the query from being sent to client server device 102 (i.e., that part of the query was not included in the second query sent to client server device 102), append module 356 can append, to the response, information regarding the removal of the blocked part of the query. As another example, if access check module 314 determined that the requestor does not have access to a particular field in the query, the append module 356 can append, to the response, information regarding the particular field inaccessible to the requestor. As another example, if rate limit module 316 determined that the requestor did not have sufficient credits to fulfill one part of the query, the append module 356 can append, to the response, information regarding that part of the query. The information can include, for example, the part of the query omitted from the second query sent to the client server device 102, the reason the part of the query was omitted, and/or error codes generated from the request.

The reduct module 358 can identify and remove information sent by client server device 102 that is not intended to reach user device 101, such as debug data. In some embodiments, the information removed from response can be based on input received from the client server device 102 (i.e., clients can specify the information to identify and remove from a generated response). Once the response has passed through process response pipeline 352, the request processing node 301 can send the updated response (i.e., the appended and/or reducted version of the response) to user device 101. The response can be further processed through post-process response pipeline 362.

The post-process response pipeline 362 can include an update rate limit module 364, an analysis module 366, and/or an update cache module 368. The analysis module 366 can analyze the response, as described with respect to response analysis module 226 and/or resource usage analysis module 228 of FIG. 2. The update rate limit module 364 can identify a rate score for the response, as described with respect to score generation module of FIG. 2. The update rate limit module 364 can update rate limit map 348 by updating the rate credits available to the requestor based on a factor corresponding to the rate score of the response. The update cache module 368 can update cache 350 with the contents of the response.

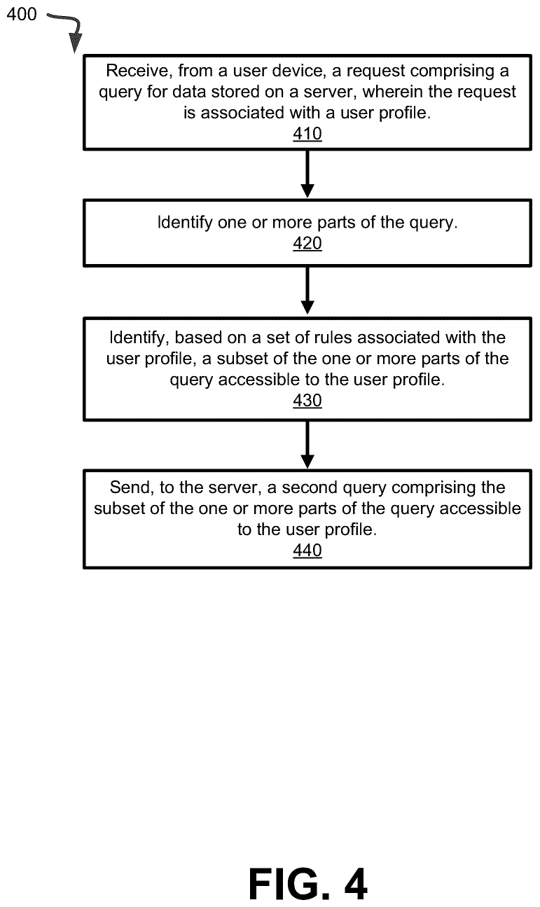

FIG. 4 is a flow diagram illustrating a method 400 for inbound rate limiting, in accordance with embodiments of the present disclosure. The method 400 may be performed by a processing logic that may comprise hardware (e.g., circuitry, dedicated logic, programmable logic, microcode, etc.), software (e.g., instructions run on a processing device to perform hardware simulation), or a combination thereof. In one embodiment, at least some operations of the method 400 can be performed by rate limiting component 103 of FIG. 1. Note that the rate limiting component 103 can perform all or parts of method 400 for multiple devices simultaneously. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, processing logic receives, from a user device (e.g., device 101A-N of FIG. 1), a request comprising a query for data stored on a server (e.g., server device 102A-B of FIG. 1). The request can be associated with a user profile. In some embodiments, processing logic can identify and remove, from the request, user data associated with the user profile (e.g., as described with regards to request sanitation module 306 of FIG. 3). For example, processing logic can identify sensitive or private data included in the request, such as passwords, or username and password combinations.

At operation 420, processing logic identifies one or more parts of the query. In some embodiments, to identify the one or more parts of the query, processing logic can parse the query (e.g., as described with respect to parsing module 220 of FIG. 2, and/or request parsing module 308 of FIG. 3). Parsing the query can include, for example, generating a syntax tree (e.g., an abstract syntax tree) for the query. The syntax tree can include a plurality of nodes and a plurality of branches. In some embodiments, the branches can represent one type of the one or more parts of the query, and the nodes can represent another type (or other types) of the one or more parts of the query. For example, the nodes can represent objects, and the objects can be of different types. The branches can represent the connections between the nodes. That is, the branches can represent the data path traversed to access the requested data object. Processing logic can determine a number of nodes for each type of node, and a number of branches.

At operation 430, processing logic identifies, based on a set of rules associated with the user profile, a subset of the one or more parts of the query accessible to the user profile. That is, processing logic can identify one or more rules that are applicable to the user profile. For example, the user profile can specify a role, and processing logic can identify the rule(s) for that role. The user profile can specify a specific user, a user type, a user group, an IP address, etc., and the processing logic can identify the rule(s) applicable to the specific user, user type, user group, and/or IP address. For example, each rule can specify to which profile, user, user type, user group, IP address, and/or any other category of users, the rule applies. In some embodiments, all rules can be applicable the user profile. For example, if the user profile does not specify a role, user type, user group, IP address, user, etc., processing logic can determine that all the rules are applicable to the user profile. Based on the rules applicable to the user profile, the processing logic can determine which part(s) of the query are accessible to the user profile. That is, the processing logic can which part(s) of the query the user profile has sufficient available rate limit credits to fulfill. In some embodiments, the subset can include all of the one or more parts of the query. In some embodiments, the set of rules associated with the user profile can include a rule associated with a rate limit of the user profile, and/or a rule associated with a type of the one or more parts of the query.

In some embodiments, to identify the subset of the one or more parts of the query accessible to the user profile, processing logic determines an object (e.g., a numerical object) for the one or more parts of the query. The object can represent an estimated amount of resources associated with fulfilling the request in embodiments. Processing logic identifies a rate limit associated with the user profile. Responsive to determining that the numerical object is less than or equal to the rate limit, processing logic determines that the one or more parts of the query are accessible to the user profile. In some embodiments, the numerical object can be an aggregate numerical object for the query, based on numerical objects associated with each part of the query.

In some embodiments, to identify the subset of the one or more parts of the query accessible to the user profile, processing logic determines a first score for a first part of the one or more parts of the query. Processing logic can identify a first rule in the set of rules associated with the user profile. The identified first rule is associated with the type of the first part. Processing logic can then compare the first score to the first rule. Based on the comparison, processing logic can determine whether the first part is accessible to the user.

In some embodiments, processing logic can identify a second subset of the one or more parts of the query that are inaccessible to the user profile (i.e., one or more parts for which the corresponding score did not satisfy the corresponding rule). Processing logic can identify information associated with the second subset, such as information describing the unsatisfied rule. Processing logic can receive a response from the server, and can send, to the user device, the response and/or the information associated with the second subset.

At operation 440, processing logic sends, to the server (e.g., client server device 102A,B of FIG. 1), a second query that includes the subset of the one or more parts of the query accessible to the profile. In some embodiments, the subset can include all of the one or more parts of the query, and thus processing logic can send the first query received from the user device to the server. In some embodiments, none of the one or more parts of the query is accessible to the user profile, and thus the subset is empty. In such embodiments, the processing logic may not send a query to the server.

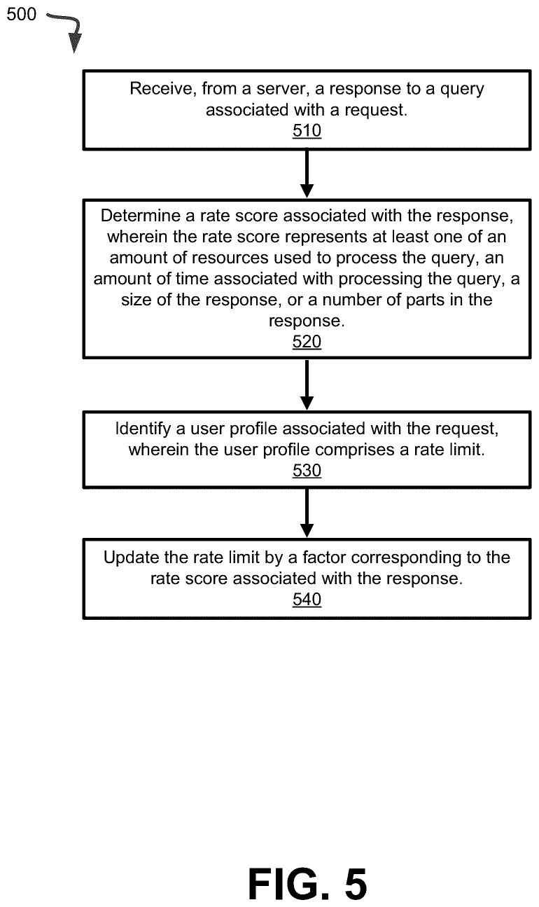

FIG. 5 is a flow diagram illustrating a method 500 for outbound rate limiting, in accordance with embodiments of the present disclosure. The method 500 may be performed by a processing logic that may comprise hardware (e.g., circuitry, dedicated logic, programmable logic, microcode, etc.), software (e.g., instructions run on a processing device to perform hardware simulation), or a combination thereof. In one embodiment, at least some operations of the method 500 can be performed by rate limiting component 103 of FIG. 1. Note that the rate limiting component 103 can perform all or parts of method 500 for multiple devices simultaneously. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 510, processing logic receives, from a server, a response to a query associated with a request. At operation 520, processing logic determines a rate score associated with the response. The rate score represents at least one of an amount of resources used to process the query, an amount of time associated with processing the query, a size of the response, or a number of parts in the response.

At operation 530, processing logic identifies a user profile associated with the request. The user profile can include, or reference, a rate limit. At operation 540, processing logic updates the rate limit by a factor corresponding to the rate score associates with the response.

In some embodiments, responsive to determining that the rate score exceeds the rate limit, processing logic sends a notification to a user device (e.g., to a user device associated with the user profile, e.g. user device 101A-N of FIG. 1). The notification can include a warning that the user profile has reached its maximum rate limit. In some embodiments, responsive to determining that the rate score exceeds a threshold, processing logic can determine not to send the response to a user device (e.g., to a user device associated with the user profile, e.g. user device 101A-N of FIG. 1).

In some embodiments, processing logic identifies, within the response, one or more extensions. An extension can be, for example, debug information. Processing logic can remove the one or more identified extensions from the response prior to sending the response to a user device (e.g., to a user device associated with the user profile, e.g. user device 101A-N of FIG. 1).

In some embodiments, processing logic identifies an original query associated with the request. Processing logic can compare the query to the original query, and based on the comparison, can identify one or more parts of the original query that were not included in the query. Processing logic can append, to the response, information associated with the one or more parts of the original query not included in the query. Such information can include, for example, information describing why the one or more parts of the original were not included in the query (e.g., which rule(s) blocked the one or more parts that were not included in the query). Processing logic can then send the response, including the appended information, to a user device (e.g., to a user device associated with the user profile, e.g. user device 101A-N of FIG. 1).

In some embodiments, processing logic identifies, in the response, personally identifying information. Processing logic can remove the identified personally identifying information from the response prior to sending the response to a user device (e.g., to a user device associated with the user profile, e.g. user device 101A-N of FIG. 1).

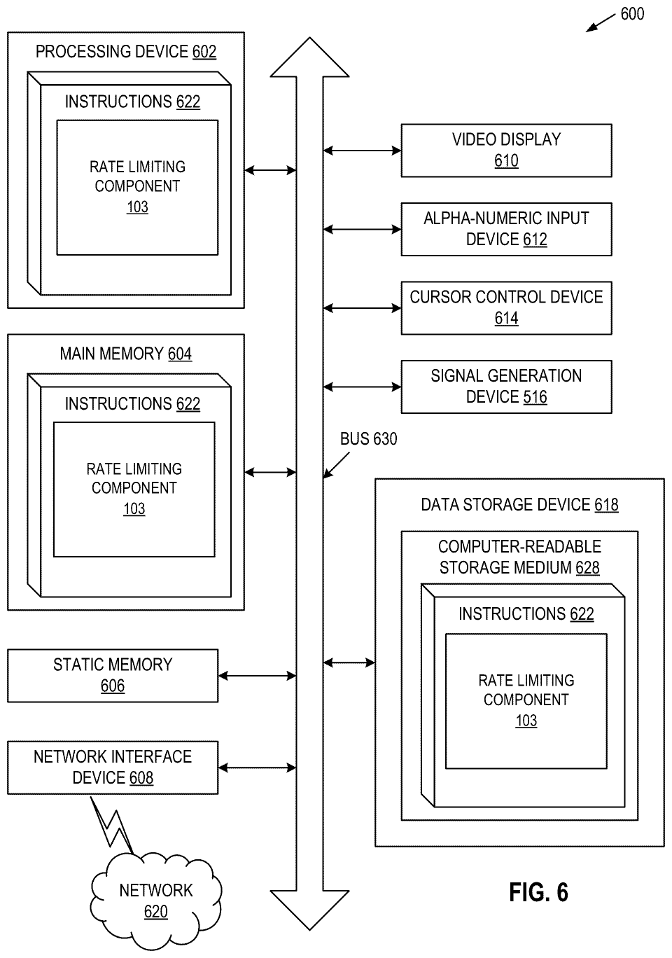

FIG. 6 illustrates a block diagram of a machine in the example form of a computing device 600 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a secondary memory (e.g., a data storage device 618), which communicate with each other via a bus 630.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 622) for performing the operations and steps discussed herein.

The computing device 600 may further include a network interface device 608 to communicate over network 620. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

The data storage device 618 may include a machine-readable storage medium (or more specifically a computer-readable storage medium) 628 on which is stored one or more sets of instructions 622 embodying any one or more of the methodologies or functions described herein. The instructions 622 may also reside, completely or at least partially, within the main memory 604 and/or within the processing device 602 during execution thereof by the computer system 600, the main memory 604 and the processing device 602 also constituting computer-readable storage media.

The computer-readable storage medium 628 may also be used to store a rate limiting component 103 (as described with reference to FIGS. 1 and 2), and/or a software library containing methods that call a rate limiting component 103. While the computer-readable storage medium 628 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies described herein. The term “computer-readable storage medium” shall accordingly be taken to include, but not be limited to, solid-state memories, and optical and magnetic media.

The modules, components and other features described herein (for example in relation to FIGS. 1-2) can be implemented as discrete hardware components or integrated in the functionality of hardware components such as ASICS, FPGAs, DSPs or similar devices. In addition, the modules can be implemented as firmware or functional circuitry within hardware devices. Further, the modules can be implemented in any combination of hardware devices and software components, or only in software.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving”, “identifying”, “determining”, “selecting”, “analyzing”, “generating”, “performing”, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the discussed purposes, or it may comprise a general purpose computer system selectively programmed by a computer program stored in the computer system. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic disk storage media, optical storage media, flash memory devices, other type of machine-accessible storage media, or any type of media suitable for storing electronic instructions, each coupled to a computer system bus.

It is to be understood that the above description is intended to be illustrative, and not restrictive. Many other embodiments will be apparent to those of skill in the art upon reading and understanding the above description. Although the present invention has been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method comprising:
receiving, from a user device, a request comprising a query for data stored on a server, wherein the request is associated with a user profile;
identifying one or more parts of the query;
identifying, based on a set of rules associated with the user profile, a subset of the one or more parts of the query accessible to the user profile; and
sending, to the server, a second query comprising the subset of the one or more parts of the query accessible to the user profile.

2. The method of claim 1, wherein identifying the subset of the one or more parts of the query accessible to the user profile comprises:
determining a score for the one or more parts of the query, wherein the score represents an estimated amount of resources associated with fulfilling the request;
identifying a rate limit associated with the user profile; and
responsive to determining that the score is less than or equal to the rate limit, determining that the one or more parts of the query are accessible to the user profile.

3. The method of claim 1, wherein identifying the subset of the one or more parts of the query accessible to the user profile comprises:
determining a first score for a first part of the one or more parts of the query;
identifying a first rule of the set of rules associated with the user profile, wherein the first rule is associated with a type of the first part;
comparing the first score to the first rule; and
determining, based on the comparing, whether the first part is accessible to the user profile.

4. The method of claim 1, further comprising:
identifying a second subset of the one or more parts of the query that are inaccessible to the user profile;
identifying information associated with the second subset;
receiving, from the server, a response; and
sending, to the user device, at least one of the responses and the information associated with the second subset.

5. The method of claim 1, wherein identifying the one or more parts of the query comprises:
generating a syntax tree for the query, wherein the syntax tree comprises a plurality of nodes and a plurality of branches, wherein a first node of the plurality of nodes represents a first type of a first part of the one or more parts, and wherein the plurality of branches represent a second type of the one or more parts;
determining a first number of nodes of the first type; and
determining a second number of branches.

6. The method of claim 1, further comprising:
removing, from the request, user data associated with the user profile.

7. The method of claim 1, wherein the set of rules associated with the user profile comprises at least one of: a first rule associated with a rate limit of the user profile, or a second rule associated with a type of one of the one or more parts.

8. A system comprising:
a memory; and
a processing device coupled to the memory, the processing device to:
receive, from a server, a response to a query associated with a request;
determine a rate score associated with the response, wherein the rate score represents at least one of an amount of resources used to process the query, an amount of time associated with processing the query, a size of the response, or a number of parts in the response;
identify a user profile associated with the request, wherein the user profile comprises a rate limit; and
update the rate limit by a factor corresponding to the rate score associated with the response.

9. The system of claim 8, wherein the processing device is further to:
identify, in the response, one or more extensions; and
remove the one or more identified extensions from the response prior to sending the response to a user device.

10. The system of claim 8, wherein the processing device is further to:
identify an original query associated with the request;
compare the query to the original query;
identify one or more parts of the original query not included in the query;
append, to the response, information associated with the one or more parts of the original query not included in the query; and
send the response to a user device.

11. The system of claim 8, wherein the processing device is further to:
identify, in the response, personally identifying information; and
remove the identified personally identifying information from the response prior to sending the response to a user device.

12. The system of claim 8, wherein the processing device is further to:
responsive to determining that the rate score exceeds the rate limit, send a notification to a user device.

13. The system of claim 8 wherein the processing device is further to:
responsive to determining that the rate score exceeds a threshold, determine not to send the response to a user device.

14. A non-transitory computer readable storage medium comprising instructions that, when executed by a processing device, cause the processing device to perform operations comprising:
receiving, from a user device, a request comprising a query for data stored on a server, wherein the request is associated with a user profile;
identifying one or more parts of the query;
identifying, based on a set of rules associated with the user profile, a subset of the one or more parts of the query accessible to the user profile; and
sending, to the server, a second query comprising the subset of the one or more parts of the query accessible to the user profile.

15. The non-transitory computer readable storage medium of claim 14, wherein identifying the subset of the one or more parts of the query accessible to the user profile comprises:
determining a score for the one or more parts of the query, wherein the score represents an estimated amount of resources associated with fulfilling the request;
identifying a rate limit associated with the user profile; and
responsive to determining that the score is less than or equal to the rate limit, determining that the one or more parts of the query are accessible to the user profile.

16. The non-transitory computer readable storage medium of claim 14, wherein identifying the subset of the one or more parts of the query accessible to the user profile comprises:
determining a first score for a first part of the one or more parts of the query;
identifying a first rule of the set of rules associated with the user profile, wherein the first rule is associated with a type of the first part;
comparing the first score to the first rule; and
determining, based on the comparing, whether the first part is accessible to the user profile.

17. The non-transitory computer readable storage medium of claim 14, the operations further comprising:
identifying a second subset of the one or more parts of the query that are inaccessible to the user profile;
identifying information associated with the second subset;
receiving, from the server, a response; and
sending, to the user device, at least one of the responses and the information associated with the second subset.

18. The non-transitory computer readable storage medium of claim 14, wherein identifying the one or more parts of the query comprises:
generating a syntax tree for the query, wherein the syntax tree comprises a plurality of nodes and a plurality of branches, wherein a first node of the plurality of nodes represents a first type of a first part of the one or more parts, and wherein the plurality of branches represent a second type of the one or more parts;
determining a first number of nodes of the first type; and
determining a second number of branches.

19. The non-transitory computer readable storage medium of claim 14, the operations further comprising:
removing, from the request, user data associated with the user profile.

20. The non-transitory computer readable storage medium of claim 14, wherein the set of rules associated with the user profile comprises at least one of: a first rule associated with a rate limit of the user profile, or a second rule associated with a type of one of the one or more parts.
